(19) United States
(12) Patent Application Publication
(10) Pub. No.: US 2002/0140840 A1
(43) Pub. Date: Oct. 3, 2002

(54) Camera for film photography and electronic photography

(76) Inventor: Takeshi Kindaichi, Tokyo (JP)

Correspondence Address: STRAUB & POKOTYLO, 1 BETHANY ROAD, SUITE 83, BUILDING 6, HAZLET, NJ, 07730, US

(21) Appl. No.: 10/086,095

(22) Filed: Feb. 27, 2002

(30) Foreign Application Priority Data
Mar. 9, 2001 (JP) 2001-067418

(51) Int. Cl. H04N 5/232; H04N 5/238; H04N 7/18

(52) U.S. Cl. 348/348; 348/351; 348/354; 348/364

(57) ABSTRACT

Briefly, a camera for film photography and electronic photography in accordance with the present invention comprising film photography mechanism for exposing a subject image on a film; a digital photography mechanism for picking up the subject image with a CCD and converting it into a digital image signal; a photometry element for measuring the brightness of the subject; a photometry unit for obtaining the subject brightness based on the image signal obtained by the digital photography mechanism; first setting means for setting the exposure conditions of the film based on the photometry results of the photometry element; second setting means for setting the image-pickup pickup conditions of the digital photography mechanism based on the photometry results of the photometry unit; control means for controlling the film photography mechanism based on the exposure conditions and controlling the digital photography mechanism based on the image-pickup conditions during a release operation; and initial conditions setting means for setting the initial image-pickup conditions of the photometry unit, this initial conditions setting means setting the initial image-pickup conditions based on the photometry results of the photometry element when the camera operation is started.

This application claims benefit of Japanese Application No. 2001-067418 filed in Japan on Mar. 9, 2001, the contents of which are incorporated by this reference.

### BACKGROUND OF THE INVENTION

1. Field of the Invention

The present invention relates to a camera for film photography and electronic photography which has an electronic photography function using a solid-state image-pickup element for photoelectric conversion of a subject image and a film photography function of exposing the subject image on a film, such a camera making it possible to actuate those electronic photography function and film photography function at the same time.

2. Description of the Related Art

Electronic photography cameras also called digital cameras have been widely used in recent years. In such cameras, an electronic image signal of a subject image is generated by photoelectric conversion of the subject image with a solid-state image-pickup element, this electronic image signal is recorded on a recording medium, and the image represented by the electronic image signal can be displayed.

Most of such electronic photography cameras can display the image of the subject immediately after it was captured and make it possible to grasp easily the angle of view of the subject or the state of photography. To employ the merits of such electronic photography cameras, the cameras for film photography and electronic photography have been developed, such cameras incorporating the above-described electronic photography structures into film photography cameras which take pictures by film exposure and have been widely used in the past.

The control of subject image obtained by the solid-state image-pickup element in the above-described electronic photography cameras is known to be performed by conducting photometry of the subject by using a subject image signal generated by photoelectric conversion with the solid-state image-pickup element and conducting the exposure control of the solid-state image-pickup element by using the photometry results.

On the other hand, in the film photography cameras, the exposure adjustment of the subject onto the film is performed by conducting photometry of the subject by using a photometry element designed for subject photometry and setting the diaphragm value and shutter speed of the photography optical system.

The photography optical system contained in the film photography cameras conducts the subject photometry by using a special photometry element with a comparatively wide dynamic range (brightness range in which the photometry is possible) and can conduct the exposure adjustment within a comparatively wide range based on the photometry results.

On the other hand, the dynamic range of the solid-state image-pickup element in the above-described electronic photography cameras is narrower than that of the photometry element in the film photography cameras. Therefore, when an extremely bright subject is photographed, the image signal output from the solid-state image-pickup element is saturated, or when a dark subject is photographed, the output of the image signals that are output from the solid-stage image-pickup element becomes insufficient and the photometry of the subject can become impossible.

Accordingly, a technology is known by which the photometry is conducted by changing the driving conditions of the solid-state image-pickup element, for example, the driving gain of the solid-state image-pickup element, or by using an extinction filter, and the exposure drive conditions of the solid-state image-pickup element at which the prescribed image signal is obtained from solid-state image-pickup element are determined.

In other words, the exposure conditions are set by changing the drive conditions of solid-state image-pickup element and executing several cycles of subject photometry. The exposure conditions in film photography cameras typically can be set by a single subject photometry, but when film photography and electronic photography are conducted at the same time, the exposure setting of electronic photography requires several cycles of photometry. As a result, a difference in time typically occurs between the exposure control operations in film photography and electronic photography.

In the conventional cameras for film photography and electronic photography, a special photometry element was provided in the film photography system for measuring the brightness of the subject and the exposure adjustment of the film photography system was conducted based on the photometry results obtained with the special photometry element, whereas in the electronic photography system, the exposure adjustment was conducted by determining the brightness of the subject from the image signal generated by a solid-state image-pickup element.

Since the special photometry element has a wide dynamic range, the brightness measurement of the subject can be conducted by a single photometry operation.

However, the dynamic range of the solid-state image-pickup element is narrow and latitude thereof is also narrow. Therefore, the brightness measurement of the subject cannot be conducted by a single photometry operation and several photometry operations have to be conducted, while changing the drive conditions of the solid-state image-pickup element.

Accordingly, when film photography and electronic photography are conducted at the same time, a time difference occurs between the exposure adjustment of film photography system conducted based on the photometry results obtained with the special photometry element and the exposure adjustment of the electronic photography system conducted based on the photometry results obtained with the solid-state image-pickup element. This difference in time creates a sense of discomfort. Furthermore, if the subject is photographed upon completion of exposure adjustment, the electronically photographed image may not match the subject image captured by film photography.

A method of exposure control of the solid-state image-pickup element by using the luminance value of the subject measured by the special photometry element designed for subject photometry conducted for exposure control in the film photography optical system may be used to eliminate the time difference in exposure control between the film photography and electronic photography.

However, though the special photometry element has a wide dynamic range and can conduct photometry at a high speed, the photometry accuracy is low. The problem was that when the photometry results obtained with the photometry element were used for the solid-state image-pickup element having a narrow dynamic range and also a narrow latitude, the exposure adjustment of the solid-state could not always be conducted accurately and at a high speed because of poor accuracy of photometry results and difference in the dynamic ranges.

### SUMMARY OF THE INVENTION

It is an object of the present invention to provide a camera for film photography and electronic photography in which the difference in time between the exposure adjustments of the film photography system and electronic photography system is greatly reduced and no sense of discomfort during operation is created by the difference in time between the exposure adjustments during simultaneous film photography and electronic photography.

Briefly, the camera for film photography and electronic photography in accordance with the present invention comprises:

a film photography mechanism for exposing a subject image on a film;

a digital photography mechanism for picking up the subject image with a CCD and converting it into a digital image signal;

a photometry element for measuring the brightness of the subject;

a photometry unit for obtaining the subject brightness based on the image signal obtained by the digital photography mechanism;

first setting means for setting the exposure conditions of the film based on the photometry results of the photometry element;

second setting means for setting the image-pickup conditions of the digital photography mechanism based on the photometry results of the photometry unit;

control means for controlling the film photography mechanism based on the exposure conditions and controlling the digital photography mechanism based on the image-pickup conditions during release operation; and

initial conditions setting means for setting the initial image-pickup conditions of the photometry unit, wherein this initial conditions setting means sets the initial image-pickup conditions based on the photometry results of the photometry element when the camera operation is started.

These objects and advantages of the present invention will become further apparent from the following detailed explanation.

### BRIEF DESCRIPTION OF THE DRAWINGS

FIG. 1 is a block diagram illustrating the configuration of the first embodiment of the camera for film photography and electronic photography in accordance with the present invention;

FIG. 2 is a flow chart illustrating the operation of the camera for film photography and the electronic photography of the aforesaid embodiment;

FIG. 3A is a timing chart illustrating the power source on switch and release switch signals in the camera of the present embodiment and the conventional camera;

FIG. 3B is a timing chart illustrating an operation example of the conventional film photography camera;

FIG. 3C is a timing chart illustrating an operation example of the conventional electronic photography camera;

FIG. 3D is a timing chart illustrating an operation example of the conventional camera for film photography and electronic photography; and

FIG. 3E is a timing chart illustrating an operation example of the camera for film photography and electronic photography of the embodiment of the present invention.

### DESCRIPTION OF THE PREFERRED EMBODIMENT

The preferred embodiment of the present invention will be described below with reference to the drawings.

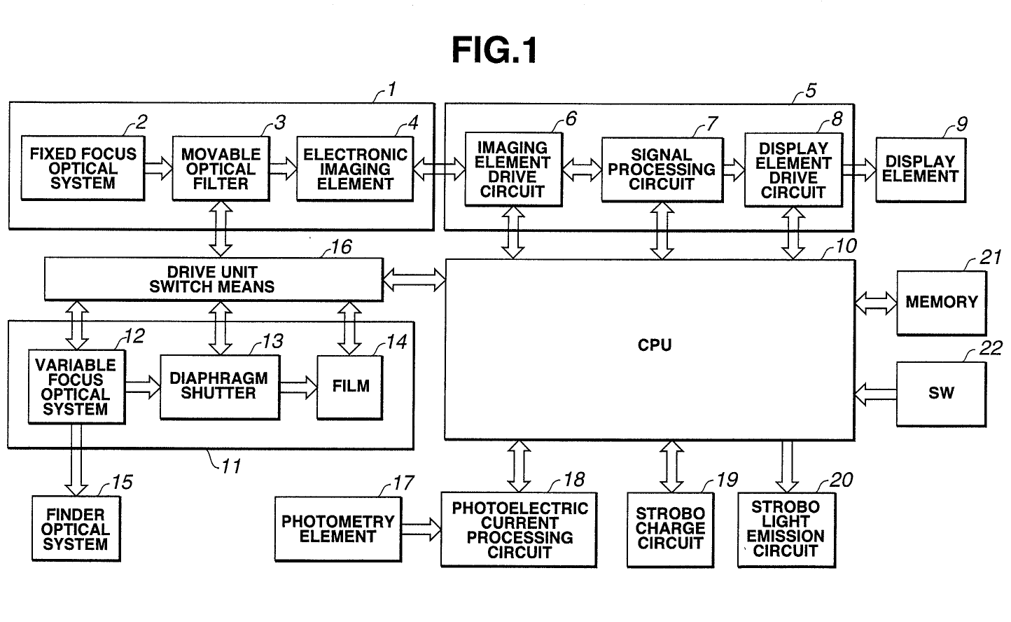

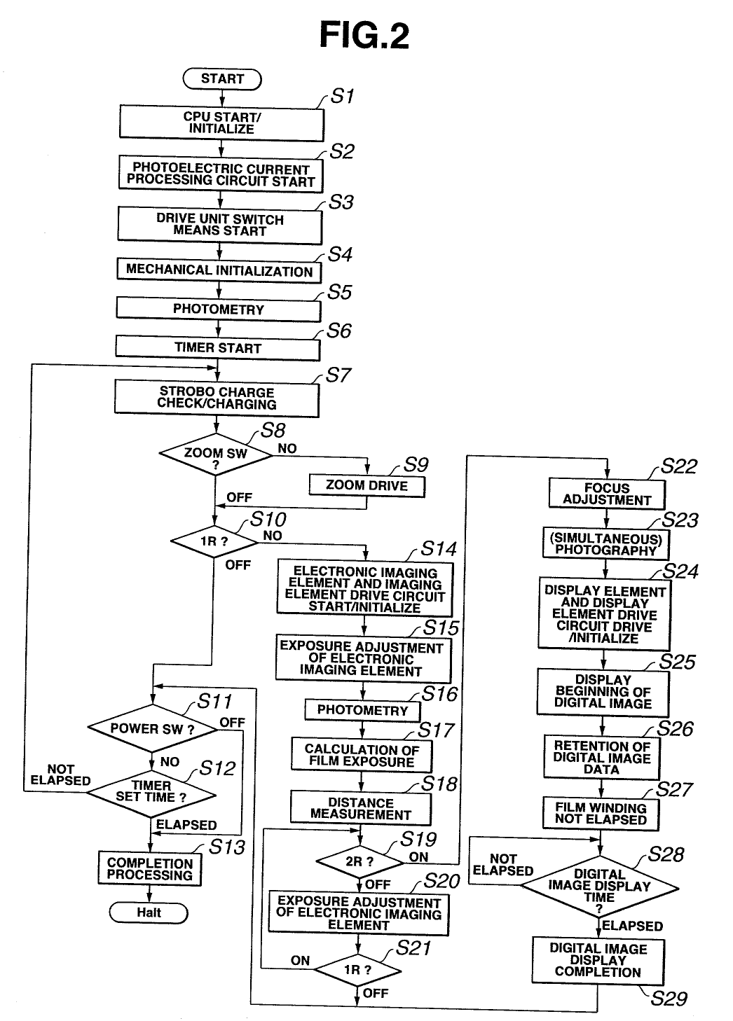

FIG. 1 is a block diagram illustrating the configuration of an embodiment of the camera for film photography and the electronic photography. FIG. 2 is a flow chart illustrating the operation of the camera for film photography and the electronic photography.

The internal structure of the camera for film photography and the electronic photography of the embodiment will be explained with reference to FIG. 1. The electronic photography device unit comprises digital photography means 1 and digital signal processing means (DSP) 5. The digital photography means 1 is composed of a fixed focus optical system 2, a movable optical filter 3, and a solid-state image-pickup element 4. Digital signal processing means 5 is composed of an image-pickup element drive circuit 6, a signal processing circuit 7, and a display element drive circuit 8.

The fixed focus optical system 2 comprises various lenses for receiving a subject light and is set with a fixed focus so that the received subject light of a certain angle of view forms an image on the below-described solid-state image-pickup element 4.

The movable optical filter 3 is composed of a plurality of ND (Neutral Density) filters. The ND filter is a filter causing the extinction of light and is designed to switch and control the amount of subject light incident upon the electronic photography element 4. When the subject light is no less than a certain value, the ND filter is inserted on an optical path of the fixed focus optical system 2 and solid-state image-pickup element 4, thereby decreasing the amount of light incident upon the solid-state image-pickup element 4. When the subject light is no more than a certain value, the ND filter is retracted from the optical path of the fixed focus optical system 2 and solid-state image-pickup element 4, and the subject light falls directly on the solid-state image-pickup element 4.

The solid-stage image-pickup element 4 uses a charge coupled element (referred to as CCD element hereinbelow) or a CMOS image-pickup element and serves to convert photoelectrically the incident subject light and to obtain an analog image signal.

The image-pickup element drive circuit 6 drives and controls the solid-stage image-pickup element 4, receives the analog image signal of the photoelectrically converted subject light, and outputs the received analog image signal to the signal processing circuit 7.

The signal processing circuit 7 is composed of circuits and functions for conducting the prescribed image signal processing, conversion to digital image data, compression and expansion processing of digital image data by the prescribed image compression and expansion method, and conversion of the expanded digital image signal to an analog image signal based on the analog image signal photoelectrically converted by the solid-state image-pickup element 4 and received by the image-pickup element drive circuit 6.

The display element drive circuit 8 drives a display element 9 composed of LCD (liquid crystal) elements and displays the subject image based on the analog image signal from the signal processing circuit 7.

The movable optical filter 3 of the digital photography means 1 and digital signal processing means 5 are driven and controlled by a microprocessor (referred to as CPU hereinbelow) 10. The compressed digital image data generated by the signal processing circuit 7 are stored in a nonvolatile memory 21 based on control from the CPU 10. The compressed digital image data stored in the memory 21 are read out based on control from the CPU 10, expanded by the signal processing circuit 7, converted into analog image signals, and supplied to the display element 9 via the display element drive circuit 8.

The CPU 10 also controls the drive of the below-described film photography device unit, in addition to the above-described electronic photography device unit. In other words, the CPU 10 controls the drive of various functions of the entire camera.

The film photography device unit will be described below. The film photography device unit comprises film photography means 11 for exposing a film to the subject light and auxiliary functions required when this film photography means 11 is driven and controlled by the CPU 10.

Film photography means 11 has various lenses receiving the subject light and also comprises a variable focus optical system 12 enabling a variable focus, and a diaphragm shutter 13 having a diaphragm function of setting the amount of subject light incident on the below-described film 14 and a shutter function of setting the incidence time. The film 14 is exposed to the subject light for the preset time at the amount of light preset by the diaphragm shutter 13.

The variable focus optical system 12 comprises a focus adjustment function for focusing the subject image on the film 14 and a zoom drive function for zooming up or down the subject image.

Further, a finder optical system 15 linked to the variable focus optical system 12 is provided. The finder optical system 15 is an optical system through which the user views the subject. This system is linked to zoom up and zoom down of the variable focus optical system 12 and makes it possible to view the subject at an angle of view identical to the angle of view of the subject exposed on the film 14.

The film photography means 11 and movable optical filter 3 of the digital photography means 1 are driven and controlled by CPU 10 via drive switch means 16.

When a signal for driving and control, for example, of the movable optical filter 3 is supplied from the CPU 10, this drive switch means 16 switches so as to drive the movable optical filter 3 and the movable optical filter 3 is driven.

If then a drive control signal causing zoom-up/zoom-down of the variable focus optical system 12 is supplied from the CPU 10, this drive switch means 16 switches to the drive of the variable focus optical system 12 and the variable focus optical system 12 is zoom-up/zoom-down driven and focus adjustment driven. At this time, the finder optical system 15 is simultaneously zoom-up/zoom-down driven.

Furthermore, if a drive control signal for driving the diaphragm shutter 13 is supplied from the CPU 10, this drive switch means 16 switches to the drive of diaphragm shutter 13 and the diaphragm shutter 13 is driven at the set diaphragm and shutter speed.

If a drive control signal actuating a film drive control function (not shown in the figures) in the course of advance feed of film 14 during film photography, idle feed when the film 14 is loaded, and rewinding of the photographed film 14 is supplied from the CPU 10, this drive switch means 16 switches to actuating a drive function of film 14 and actuates the film drive function.

A photometer element 17 designed for photometry by which the brightness of the subject is measured and a photoelectric current processing circuit 18 for detecting the brightness of the subject based on the photoelectric current generated according to the brightness of the subject detected by the photometer element 17 are connected to the CPU 10. The photometer element 17 generates a photoelectric current according to the projected subject light. The photoelectric current is compared with the reference value in the photoelectric current processing circuit 18 and the CPU 10 calculates and determines the diaphragm value and shutter speed of the diaphragm shutter 13.

Furthermore, a strobo charge circuit 19 and a strobo light emission circuit 20 are connected to the CPU 10. The strobo charge circuit 19 charges a capacitor with a light emission power supplied to a strobo (not shown in the figures). The strobo light emission circuit 20 controls the strobo light emission by using the strobo light emission power source obtained by charging the strobo (not shown in the figures) with the strobo charge circuit 19.

Furthermore, a switch 22 is connected to the CPU 10. The switch 22 is composed of a variety of operation switches such as a power source switch for drive power supply which drives the entire camera, a selector switch for selecting electronic photography or film photography, or simultaneous electronic photography and film photography, a control switch of zoom-up/zoom-down of the variable focus optical system 12, a release switch of photographic indication, and the like.

The CPU 10 stores various control processing data corresponding to operation switches of the switch 22.

Taking pictures with the camera for film photography and electronic photography of such configuration will be described below.

In step S1, if a power switch which is a camera drive power switch of the switch 22 is turned on, the camera is transferred from a power saving state into an operation state. In this state, electronic photography functions such as the drive of solid-state image-pickup element 4 and digital signal processing means 5 are initialized and a film photography function of driving the variable focus optical system 12 of film photography means 11 from a collapsed position in the camera body (position in which pictures cannot be taken) into a WIDE position (position in which pictures can be taken) is initialized under control by the CPU 10.

Then, in step S2, the photometry element 17 and photoelectric current processing means 18 are driven under control by the CPU 10. Then, in step S3, the drive switch means 16 is controlled and switched so that a drive power is transferred to the variable focus optical system 12 of film photography means 11 under control by the CPU 10.

Once switching of drive switch means 16 of step S3 has been completed, in step S4, the variable focus optical-system of film photography means 11 is driven and drawn out from the collapsed position in the camera body (position in which pictures cannot be taken) into a WIDE position (position in which pictures can be taken) and mechanical initialization of film photography is conducted.

Then, in step S5, the subject light is measured with the photometry element 17 and photoelectric current processing circuit 18 actuated in step S2. In the photometry, the amount of incident light is converted into electric current with the photometry element 17 and this photoelectric current is calculated as the brightness of the subject with the photoelectric current processing circuit 18 and output to the CPU 10.

On the basis of brightness supplied from the photoelectric current processing circuit 18, the CPU 10 generates the exposure adjustment signals such as the drive of movable optical system filter 3 and gain of an amplification circuit or electronic shutter of solid-state image-pickup element 4 (initial image-pickup conditions) and conducts exposure adjustment of the digital photography means 1. The exposure control of diaphragm shutter 13 of film photography means 11 can be also simultaneously conducted during photometry in step S5.

Once the photometry processing of step S5 has been completed, in step S6, a time start of clock function (not shown in the figures) of CPU 10 is conducted. The time start of the clock function represents time measurement set in a power-saving mode to save the power of the drive power source of the camera when a variety of below-described photographic actions are not executed within the preset time after the initialization actions conducted in steps S1 to S5.

If a processing of timer start of step S6 is completed, in step S7, the charged electric charge of the capacitor of the strobo light emission power source (not shown in the figure) is checked via the strobo charge circuit 19, and if the capacitor does not have the preset charged electric charge, it is charged up to the preset charged electric charge by actuation and control of the charge circuit 19.

Then, in step S8, a decision is made as to whether a zoom switch, either a zoom-up or zoom-down switch, of the switch 22 was turned on, and if a decision is made that the zoom switch was turned on, the variable focus optical system 12 is zoom driven in step S9. If the zoom-up switch is turned on, this zoom drive switches the drive switch means 16 to the drive of variable focus optical system 12 and draws out the variable focus optical system 12 from the WIDE position to a TELE (remote) position, and if the zoom-down switch is turned on, the variable focus optical system 12 is returned from the TELE (remote) position to the WIDE position.

If in step S8 a decision was made that the zoom switch was not turned on or if the zoom drive of step S9 is completed, in step S10, a decision is made as to whether the first release switch (1R) of the release switches of switch 22 was turned on. This release switch has a two-stage configuration. If the release button is in a half-pushed state, the first release switch (1R) is turned on and if the release button is further pushed to a full-pushed state, the second release switch (2R) is turned on.

If the first release switch (1R) of the release switches is turned on, actions of step S14 and subsequent steps are executed, and if the first release switch (1R) is turned off, actions of step S11 and subsequent steps are executed.

If a decision is made that the first release switch (1R) is turned off in step S10, in step S11, a decision is made as to whether the power switch of the camera is turned on, and if the power switch is turned on, the completion processing of step S13 is executed, whereas if the power switch is turned off, in step S12, a decision is made as to whether the set prescribed time has elapsed from the moment of time when the timer start has been conducted in step S6. If the set prescribed time has not elapsed, the program returns to step S7, and if the set prescribed time has elapsed, the completion processing is conducted in step S13.

In the completion processing of step S13, if any of the switches of the switch 22 has been turned on, the ON action of this switch is detected and a power-saving mode is implemented in which the lowest drive power for actuating the CPU 10 in a stand-by mode is supplied to execute the processing action corresponding to this switch, or when the power switch is turned off, the variable focus optical system 12 is driven from the WIDE position to the collapsed position in the camera body and a waiting state of the operation of various switches of the switch 22 or operation of the power switch is implemented.

If in step S10 a decision is made that the first release switch (1R) was turned on, then in step S14 the solid-state image-pickup element 4, image-pickup element drive circuit 6, and signal processing circuit 7 are actuated under control by the CPU 10, the subject image signals generated from the subject light received by the solid-state image-pickup element 4 are obtained, the image signals of the prescribed region of those obtained subject image signals are integrated, and the average brightness value of the image signal is calculated. In step S15, based on the subject brightness value calculated in step S14, the CPU 10 conducts the exposure adjustment of the solid-state image-pickup element 4, such as a drive control of the movable optical filter 3 by switching the drive switch means 16 and a drive control of the electronic shutter of the solid-state image-pickup element 4 by the image-pickup element drive circuit 6.

The exposure adjustment of solid-state image-pickup element 4 in step S15 is actuated by the initial image-pickup conditions of digital photography means 1 as provisional image-pickup conditions and the brightness value of the image signal obtained from the solid-state image-pickup element 4 is set as new image-pickup conditions of digital photography means 1 of the next cycle based on the photometry results processed in the photometry element 17 and photoelectric current processing circuit 18 when the drive power was supplied to the camera in step S3. Therefore, the exposure adjustment of this digital photography means 1 is completed within a short time.

Then, in step S16, the CPU 10 actuates the photometry element 17 and photoelectric current processing circuit 18 and conducts photometry of the subject. The CPU 10, in step S17, based on the photometry results, calculates the diaphragm value of diaphragm shutter 13 of film photography means 11 by using a DX code of film sensitivity (not shown in the figure) set on the film 14 and also calculates the exposure adjustment values (exposure conditions) such as a shutter speed.

If the exposure adjustment value of film photography means 11 is calculated in step S17, the distance to the subject is measured with range finding means (not shown in the figure) in step S18 and the CPU 10 adjusts the focus of variable focus optical system 12 via drive switch means 16 based on the distance measurement results. Here, the CPU 10 measures the distance to the subject with range finding means for measuring the distance to the subject. Based on-the measured distance and the present position of the variable focus optical system 12, the CPU 10 calculates the drive amount of the variable focus optical system 12 to a focal position in which an image of the subject is formed on the film 14 and drives and controls the variable focus optical system 12 based on the drive amount.

Once the measurement of distance to the subject and drive of the variable focus optical system 12 in step S18 has been completed, the CPU 10 in step S19 decides as to whether the second release switch (2R) of the release switches was turned on.

If a decision is made that the second release switch (2R) was turned off, an exposure adjustment of the solid-state image-pickup element 4 is again executed in step S20 in the same manner as in step S15, and a decision relating to the state of the first release switch (1R) is again made in step S21. If the first release switch (1R) is turned on, the program returns to step S19 and if it is turned off, then step S11 and subsequent steps are executed.

If a decision is made in step S19 that the second release switch (2R) is turned on, then in step S22 the CPU 10 conduct focus adjustment by driving the variable focus optical system 12 based on the distance to the subject measured in step S18 and the drive amount of variable focus optical system 12 calculated from the present position of the variable focus optical system 12.

If focus adjustment of step S22 is completed, the film photography and electronic photography are simultaneously conducted in step S23.

In photography of step S23, the digital photography means 1 conducts the exposure control of the solid-state image-pickup element 4 based on the exposure adjustment value of solid-state image-pickup element 4 determined in step S15 and also conducts the electronic photography. On the other hand, the film photography means 11 drives the diaphragm shutter 13 based on the exposure adjustment value of the film photography means 11 determined in step S17 and conducts film photography.

Then, in step S24, the prescribed image signal processing is conducted in the signal processing circuit 7 with respect to the image signal generated in the digital photography means 1 in step S23. As a result, signal processing such as generation of digital image data and supply of the display image signal to the display element 9 is executed.

In step S25, under control by the CPU 10, the display element 9 is driven and controlled by the display element drive circuit 8 and the subject image obtained based on the signals supplied from the signal processing circuit 7 is displayed.

Then, in step S26, the CPU 10 causes the memory 21 to write, memorize, and store the digital image data generated by the signal processing circuit 7. When the memorization and storage in memory 21 of step S26 is completed, in step S27, in order to wind up one frame of the film 14 exposed by the subject in the photography drive of the film photography means 11, the drive switch means 16 is switched to the film drive function and the film 14 is wound up by one frame.

Then, in step S28, the CPU 10 calculates the display time of the subject image displayed by the display element 9 in step S25 and decides whether the prescribed time has elapsed. When the prescribed time has not elapsed for the subject image displayed by the display element 9, the CPU 10 again measures the display time on the display element 9. If in step S28 a decision is made that the prescribed time has elapsed for displaying the subject image on display element 9, the CPU 10 stops the display operation of display element 24 in step S29 and executes processing of step S11 and subsequent steps.

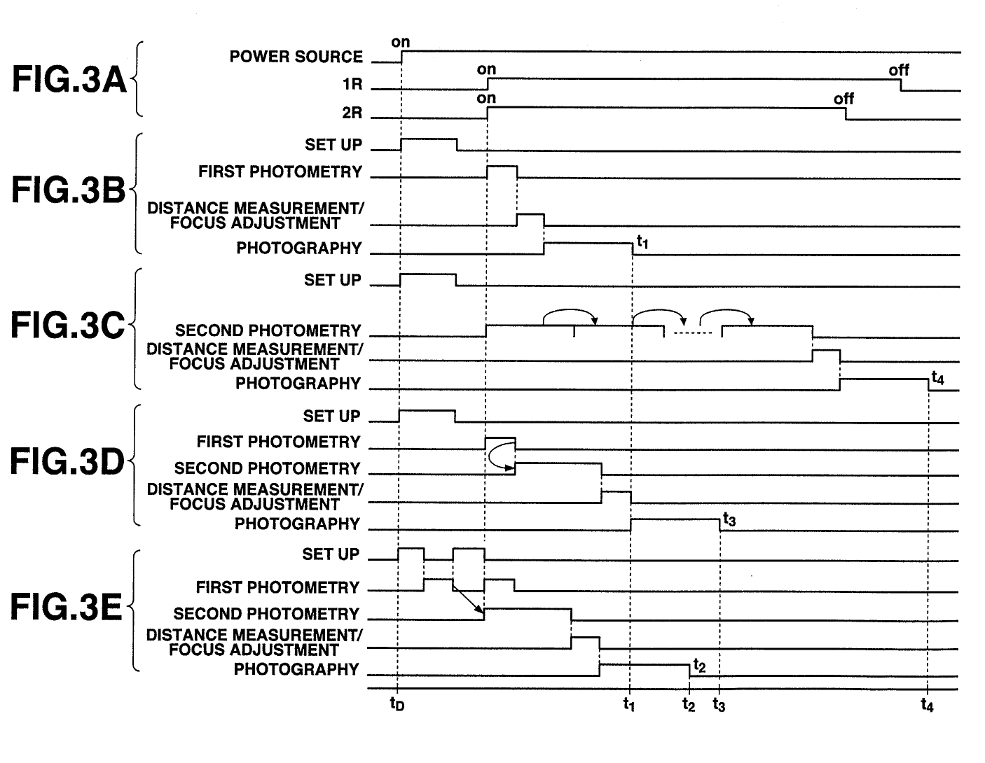

The operation timing of the camera for film photography and electronic photography which is capable of simultaneous film photography and electronic photography will be explained below with reference to time charts shown in FIG. 3A to FIG. 3E.

FIG. 3A is a timing chart showing a power-on switch signal and release switch signal in the camera of the present embodiment and the conventional camera. FIG. 3B is a timing chart illustrating an operation example of conventional film photography cameras. FIG. 3C is a timing chart illustrating an operation example of conventional electronic photography cameras. FIG. 3D is a timing chart illustrating an operation example of conventional cameras for film photography and electronic photography. FIG. 3E is a timing chart illustrating an operation example of the camera as film photography and electronic photography of the embodiment of the present invention. FIGS. 3B to 3E are the time charts of the respective cameras from the moment the power switch is turned on for power supply to the photography operation causing on/off of the release switch.

The “first photometry,” in FIGS. 3B, 3D, and 3E is implemented for conducting a subject photometry with the special photometry element 17 and conducting an exposure adjustment of the film photography system based on the photometry results. The “second photometry” in FIG. 3C is implemented for conducting a subject photometry from an image signal generated by the solid-state image-pickup element and conducting an exposure adjustment of the digital imaging system based on the photometry results.

If the power switch supplying drive power to the respective cameras is turned on, each camera conducts a photography setup operation. In the conventional film photography camera, this setup operation, as described above, comprises driving the film photography means from a collapsed position in which pictures cannot be taken to a WIDE position in which pictures can be taken. In the conventional digital camera, the setup is initialized and conducted by supplying a drive power to the digital photography means. In the conventional hybrid camera, the set-up is conducted by driving the film photography means to the position in which pictures can be taken and by initializing the digital photography means.

Then, if the first release switch (1R) and second release switch (2R) of the release switch are successively turned on, in the conventional film photography camera, the subject photometry by the first photometry is executed and then the distance to the subject is measured and the focus adjustment of the film photography optical system is conducted based on the measured distance. When those distance measurement and focus adjustment are completed, the photographic exposure is executed based on the first photometry and the photography is completed at a time t1.

In the conventional digital camera, the second photometry is started if the first release switch (1R) and second release switch (2R) are successively turned on. In the second photometry, a movable optical filter is driven or the driving conditions of the solid-state image-pickup element are changed, the photometry is repeated several times, and the exposure conditions with the best efficiency of image signal conversion of the solid-state image-pickup element are set. Once the exposure conditions of the solid-state image-pickup element has been set, the distance measurement and focus adjustment are conducted, electronic photography by the solid-state image-pickup element is executed, and the photography is completed at a time t4.

In other words, since the image signal from the solid-state image-pickup element is obtained from each 1 frame (1/30 seconds), 1/30 seconds is required for one cycle of photometry. Because of such increase in the number of photometry cycles, time is required for exposure setting of the solid-state image-pickup element.

In the conventional hybrid camera, if the first release switch (1R) and second release switch (2R) are successively turned on, subject photometry by the first photometry is conducted and the exposure of the solid-state image-pickup element is preset based on the results of this first photometry. Since the accuracy of this first photometry, as described above, is not that good, the accurate exposure of the solid-state image-pickup element is set by the second photometry. Once the exposure adjustment by the first photometry and second photometry has been completed, the distance measurement and focus adjustment are conducted, exposure on the film and electronic photography with the solid-state image-pickup element are executed, and the photography is completed at a time t3.

On the other hand, in the camera of the present embodiment, if the power switch is turned on, after the setup of the film photography system, photometry of the subject is conducted by the first photometry and the exposure adjustment of the digital photography means in the setup is executed based on the results of the first photometry. In other words, as described with reference to the photometry of step S5 (see FIG. 2), the temporary exposure adjustment of digital photography means 1 such as an electronic shutter of solid-state image-pickup element 4 and drive of movable optical system filter 3 are conducted and the setup of digital photography means is carried out based on the results of the first photometry.

If then the first release switch (1R) and second release switch (2R) are continuously turned on, the first photometry is executed together with the second photometry, the exposure of film photography means 11 is set based on the results of first photometry and the exposure of digital photography means 1 is set based on the results of second photometry. In such exposure setting of digital photography means 1, the exposure is reset from the exposure set state that was temporarily set based on the results of first photometry during the setup. Therefore, exposure setting of digital photography means 1 can be conducted within a short time.

Once the exposure setting by the first photometry and second photometry has been completed, the distance measurement and focus adjustment are conducted, the exposure on the film and electronic photography with the solid-state image-pickup element are conducted, and the photography is completed at a time t2.

Thus, in the camera for film photography and electronic photography in accordance with the present invention, the photometry is conducted during the setup of the film photography and electronic photography systems immediately after the power switch of the camera has been turned on and the exposure of the electronic photography system is temporarily set based on the photometry results. Therefore, the final exposure setting of the electronic photography system can be conducted within a short time when the release switch is operated and the film photography and electronic photography are conducted at the same time.

Furthermore, if any switch of switch 22 is operated when the camera is in a waiting state of a power saving mode, a setup state is immediately obtained and an exposure setting of the digital photography system 1 is executed by the first photometry. Therefore, the exposure setting of the film photography and digital photography by the release switch operation can be conducted within a short time.

The effect produced is that the difference in time between the exposure controls of film photography and electronic photography when the film photography and electronic photography are conducted at the same time becomes unnoticeable for the user.

Thus in the camera for film photography and electronic photography of the present embodiment, the photometry and exposure setting of the electronic photography system during simultaneous photography can be shortened by actuating a special photometry means when the power switch is turned on, conducting photometry of the subject, and temporarily setting the exposure of electronic photography system based on the photometry results.

As a consequence, a camera for film photography and electronic photography can be provided in which the difference in time between optimum exposure settings of film photography and electronic photography can be shortened and no sense of discomfort is created in the user.

In this invention, it is apparent that working modes different in a wide range can be formed on the basis of this invention without departing from the spirit and scope of the invention. This invention is not restricted by any specific embodiment except being limited by the appended claims.

What is claimed is:

1. A camera for film photography and electronic photography comprising:
film photography means for exposing a subject image on a film;
digital photography means for picking up said subject image with a solid-state image-pickup element and converting it into a digital image signal;
first photometry means for measuring the brightness of the subject with a photometry element;
second photometry means for actuating said digital photography means and measuring the brightness of said subject based on the image signal thus obtained;
first setting means for actuating said first photometry means and setting the exposure conditions of said film in said film photography means based on the photometry results;
second setting means for setting image-pickup conditions of said digital photography means based on the photometry output of said second photometry means;
control means for controlling said film photography means based on the exposure conditions set by said first setting means and controlling said digital photography means based on the image-pickup conditions set by said second setting means when a release operation is conducted; and
initial conditions setting means for setting the initial image-pickup conditions in said second photometry means, said initial conditions setting means actuating said first photometry means when said camera operation is started and setting said initial image-pickup conditions based on the photometry results.

2. The camera for film photography and electronic photography according to claim 1, wherein said initial conditions setting means sets the initial value of the electronic shutter speed of said digital photography means or the initial value of the gain of an amplification circuit based on the photometry output of said first photometry means.

3. The camera for film photography and electronic photography according to claim 1, wherein said digital photography means comprises a plurality of optical filters for adjusting the amount of light incident on said solid-state image-pickup element, and said initial conditions setting means conducts the initial setting of said optical filters based on the output of said first photometry means.

4. The camera for film photography and electronic photography according to claim 1, further comprising starting means for making the operation state of said camera shift from the power saving state to the operation state in response to a manual operation, wherein said initial conditions setting means actuates said first photometry means after said camera has been started by said starting means.

5. The camera for film photography and electronic photography according to claim 1, wherein said first photometry means comprises a photometry element and a photoelectric current processing circuit for processing the photoelectric current output from said photometry element.

6. The camera for film photography and electronic photography according to claim 1, wherein said initial conditions setting means sets at least one of the following: an a mount of subject light incident on said solid-state image-pickup element, an electronic shutter speed of said solid-state image-pickup element, and a gain during amplification of the output signal of said solid-state image-pickup element.

7. A camera for film photography and electronic photography comprising:
film photography means for exposing a subject image on a film;
digital photography means for imaging said subject image with a solid-state image-pickup element and converting it into a digital image signal;
photometry means for measuring the brightness of the subject with a photometry element;
initial conditions setting means for actuating said photometry means when said camera operation is started and setting the initial image-pickup conditions of said digital photography means based on the photometry value obtained as a result of said photometry actuation;
image-pickup conditions setting means for actuating said digital photography means under the image-pickup conditions set by said initial conditions setting means and setting the image-pickup conditions of the next cycle based on the subject brightness values thus obtained; and
exposure conditions setting means for actuating said photometry means in response to a release operation and setting the exposure conditions of said film exposure means based on the photometry values obtained by said photometry operation.

8. A camera comprising:
digital photography means for picking up digital images of a subject;
photometry means for measuring the brightness of the subject with a photometry element; and
setting means for setting the image-pickup conditions of the next cycle based on the past image-picked-up results of said digital photography means, wherein the initial image-pickup conditions of said digital photography means are set based on the output of said photometry means.

9. The camera according to claim 8, wherein the initial photography conditions of said digital photography means are set based on the output of said photometry means obtained when the operation of said camera is started.

10. A camera comprising:
a start switch of said camera;
an image-pickup element;
an image-pickup element drive circuit for driving said image-pickup element;
a signal processing circuit for processing the image signal that is formed by said image-pickup element;
a photometry element for measuring the brightness of a subject;
a photoelectric current processing circuit for processing the photoelectric current output from said photometry element; and
a CPU for actuating said photometry element in response to an operation of said start switch and instructing the initial operation conditions of said image-pickup element to said image-pickup element drive circuit based on the data on the brightness of the subject processed by said signal processing circuit.

11. The camera according to claim 10, wherein said image-pickup element drive circuit, in image-pickup operation of the second cycle and subsequent cycles of said image-pickup element, sets the operation conditions of the next cycle based on the image signal obtained by the previous image-pickup operation.
